(19) United States
(12) Patent Application Publication
(10) Pub. No.: US 2021/0075060 A1
(43) Pub. Date: Mar. 11, 2021

(54) NON-AQUEOUS ELECTROLYTE SECONDARY BATTERY

(71) Applicant: TOYOTA JIDOSHA KABUSHIKI KAISHA, Toyota-shi (JP)

(72) Inventor: Tetsuri NAKAYAMA, Okazaki-shi (JP)

(73) Assignee: TOYOTA JIDOSHA KABUSHIKI KAISHA, Toyota-shi (JP)

(21) Appl. No.: 16/999,355

(22) Filed: Aug. 21, 2020

(30) Foreign Application Priority Data
Sep. 10, 2019 (JP) 2019-164880

(51) Int. Cl. H01M 10/0563; H01M 4/64; H01M 4/48

(52) U.S. Cl. CPC H01M 10/0563; H01M 2004/027; H01M 4/483; H01M 4/64

(57) ABSTRACT

A non-aqueous electrolyte secondary battery disclosed herein includes a positive electrode, a negative electrode, and a non-aqueous electrolyte. The positive electrode includes a positive electrode current collector and a positive electrode active material layer provided on the positive electrode current collector. The non-aqueous electrolyte contains lithium fluorosulfonate. The positive electrode active material layer contains a positive electrode active material. The positive electrode active material layer contains hydrated alumina at least in a surface layer portion.

### INCORPORATION BY REFERENCE

The disclosure of Japanese Patent Application No. 2019-164880 filed on Sep. 10, 2019 including the specification, drawings and abstract is incorporated herein by reference in its entirety.

### BACKGROUND

### 1. Technical Field

The present disclosure relates to a non-aqueous electrolyte secondary battery.

### 2. Description of Related Art

In recent years, a non-aqueous electrolyte secondary battery such as a lithium ion secondary battery is suitably used in a portable power supply for personal computers, portable terminals, or the like, and a power supply for vehicle drive of electric vehicles (EV), hybrid vehicles (HV), plug-in hybrid vehicles (PHV), or the like.

With spread of non-aqueous electrolyte secondary batteries, higher performance is desired. There is known a technique of adding lithium fluorosulfonate to a non-aqueous electrolyte in order to improve a performance of the non-aqueous electrolyte secondary battery (for example, see Japanese Unexamined Patent Application Publication No. 2018-181855 (JP 2018-181855 A)).

### SUMMARY

However, as a result of intensive studies by the present inventor, it was found that a technique of related art in which a non-aqueous electrolyte contains lithium fluorosulfonate has a problem in low-temperature performance. Specifically, it was found that the technique of the related art has a problem that a discharge capacity when a large current flows at low temperature is not sufficient.

The present disclosure provides a non-aqueous electrolyte secondary battery in which lithium fluorosulfonate is added to a non-aqueous electrolyte, and which is excellent in low-temperature performance.

An aspect of the present disclosure relates to a non-aqueous electrolyte secondary battery including a positive electrode, a negative electrode, and a non-aqueous electrolyte. The positive electrode includes a positive electrode current collector and a positive electrode active material layer provided on the positive electrode current collector. The non-aqueous electrolyte contains lithium fluorosulfonate. The positive electrode active material layer contains a positive electrode active material. The positive electrode active material layer contains hydrated alumina at least in a surface layer portion.

With this configuration, it is possible to provide a non-aqueous electrolyte secondary battery in which lithium fluorosulfonate is added to a non-aqueous electrolyte, and which is excellent in low-temperature performance.

In a region of the positive electrode active material layer where the hydrated alumina is contained, a content of the hydrated alumina may be 1% by mass or more and 30% by mass or less, with respect to the positive electrode active material contained in the region.

With this configuration, the effect of improving the low-temperature performance is particularly high, and a battery capacity increases.

The non-aqueous electrolyte may further contain lithium bis(oxalato)borate.

With this configuration, the effect of improving the low-temperature performance increases more.

The non-aqueous electrolyte may further contain lithium difluorophosphate.

With this configuration, the effect of improving the low-temperature performance increases more.

The hydrated alumina may be aluminum oxyhydroxide.

With this configuration, the effect of improving the low-temperature performance increases more.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view schematically showing an internal structure of a lithium ion secondary battery according to an embodiment of the present disclosure; and

FIG. 2 is a schematic view showing a configuration of a wound electrode body of a lithium ion secondary battery according to an embodiment of the present disclosure.

### DETAILED DESCRIPTION OF EMBODIMENTS

Hereinafter, embodiments of the present disclosure will be described with reference to the drawings. Matters other than those specifically mentioned in the present specification, which are needed for carrying out the present disclosure (for example, a general configuration and a manufacturing process of a non-aqueous electrolyte secondary battery which does not characterize the present disclosure) can be grasped as design matters of those skilled in the art based on conventional techniques in the field. The present disclosure can be implemented based on the contents disclosed in the present specification and common technical knowledge in the field. In the following drawings, members and portions having the same function are denoted by the same reference numerals. The dimensional relationships (such as length, width, and thickness) in each drawing do not reflect actual dimensional relationships.

In the present specification, a “secondary battery” generally refers to a power storage device that can be repeatedly charged and discharged, and is a term that includes a so called storage battery and a power storage element such as an electric double layer capacitor.

Also, a “non-aqueous electrolyte secondary battery” refers to a battery provided with a non-aqueous electrolyte (typically, a non-aqueous electrolyte containing a supporting electrolyte in a non-aqueous solvent).

Hereinafter, the present disclosure will be described in detail using an example of a flat rectangular lithium ion secondary battery having a flat wound electrode body and a flat battery case, but it is not intended that the present disclosure is limited to those described in such embodiments.

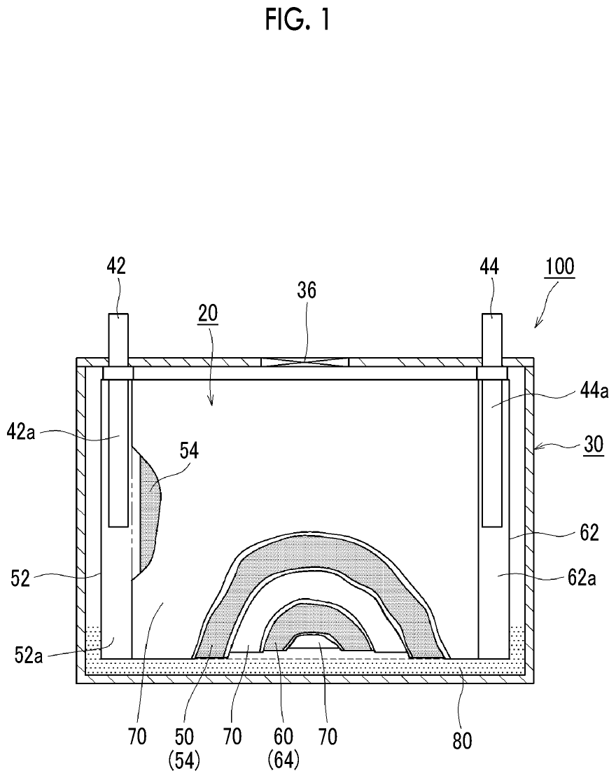

A lithium ion secondary battery 100 shown in FIG. 1 is a sealed battery configured by housing a flat wound electrode body 20 and a non-aqueous electrolyte 80 in a flat rectangular battery case (that is, an outer container) 30. The battery case 30 is provided with a positive electrode terminal 42 and a negative electrode terminal 44 for external connection, and a thin safety valve 36 set to release internal pressure when the internal pressure of the battery case 30 increases to a predetermined level or higher. In addition, the battery case 30 is provided with an inlet (not shown) for injecting the non-aqueous electrolyte 80. The positive electrode terminal 42 is electrically connected to a positive electrode current collector plate 42a. The negative electrode terminal 44 is electrically connected to a negative electrode current collector plate 44a. As a material of the battery case 30, for example, a metal material, which is good in heat conductivity with lightweight, such as aluminum is used. FIG. 1 does not accurately represent the amount of the non-aqueous electrolyte 80.

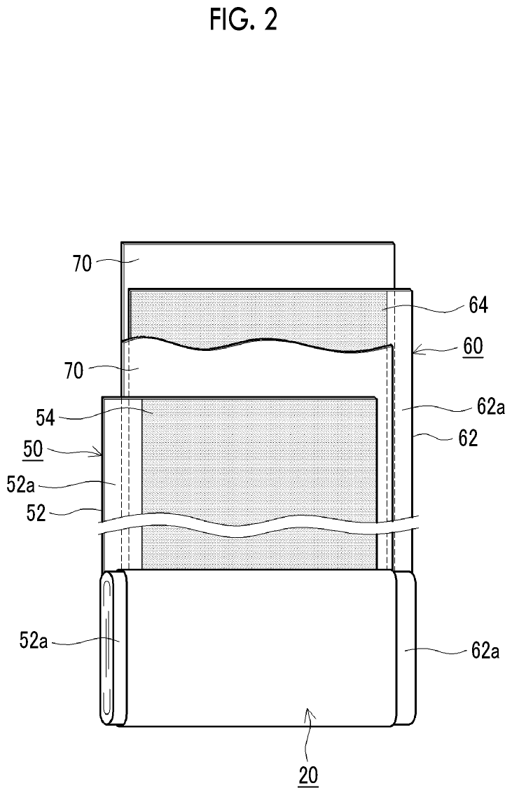

As shown in FIGS. 1 and 2, the wound electrode body 20 is layered body in which a positive electrode sheet 50 in which a positive electrode active material layer 54 is formed on one or both sides (here, both sides) of a long positive electrode current collector 52 along a longitudinal direction and a negative electrode sheet 60 in which a negative electrode active material layer 64 is formed on one side or both sides (here, both sides) of a long negative electrode current collector 62 along the longitudinal direction are overlapped via two long separator sheets 70. The wound electrode body 20 has a form in which the layered body is wound in the longitudinal direction. In addition, the positive electrode current collector plate 42a and the negative electrode current collector plate 44a are joined to a positive electrode active material layer non-formed portion 52a (that is, a portion where the positive electrode current collector 52 is exposed without forming the positive electrode active material layer 54) and the negative electrode active material layer non-formed portion 62a (that is, a portion where the negative electrode current collector 62 is exposed without forming the negative electrode active material layer 64), which are formed to protrude outward from both ends in the winding axis direction (that is, the sheet width direction perpendicular to the longitudinal direction) of the wound electrode body 20, respectively.

Examples of the positive electrode current collector 52 configuring the positive electrode sheet 50 include an aluminum foil.

The positive electrode active material layer 54 contains a positive electrode active material. As the positive electrode active material, a known positive electrode active material used for a lithium secondary battery may be used. Specifically, for example, a lithium composite oxide or a lithium transition metal phosphate compound can be used. A crystal structure of the positive electrode active material is not particularly limited, and may be a layered structure, a spinel structure, an olivine structure, or the like.

As the lithium composite oxide, a lithium transition metal composite oxide containing at least one of Ni, Co, and Mn as a transition metal element is preferable. Specific examples of the lithium transition metal element include a lithium nickel-based composite oxide, a lithium cobalt-based composite oxide, a lithium manganese-based composite oxide, a lithium nickel manganese-based composite oxide, a lithium nickel cobalt manganese-based composite oxide, a lithium nickel cobalt aluminum-based complex oxide, and a lithium iron nickel manganese-based composite oxide.

Since an initial resistance is small, the lithium composite oxide preferably has a layered structure. The lithium composite oxide is more preferably a lithium nickel cobalt manganese-based composite oxide having a layered structure. A content of the nickel relative to a total content of the nickel, manganese, and cobalt in the lithium nickel manganese cobalt-based composite oxide is not particularly limited, but is preferably 34 mol % or more. In this case, a resistance of the lithium ion secondary battery 100 decreases and the capacity increases.

In the present specification, the “lithium nickel cobalt manganese-based composite oxide” is a term including, in addition to an oxide having Li, Ni, Co, Mn, and O as a constituent element, and an oxide including one or more kinds of additional elements. Examples of the additional element include transition metal elements such as Mg, Ca, Al, Ti, V, Cr, Si, Y, Zr, Nb, Mo, Hf, Ta, W, Na, Fe, Zn, and Sn and typical metal elements. In addition, the additional element may be semimetal elements such as B, C, Si, and P, and nonmetal elements such as S, F, Cl, Br, and I. The same is applied to the lithium nickel-based composite oxide, the lithium cobalt-based composite oxide, the lithium manganese-based composite oxide, the lithium nickel manganese-based composite oxide, the lithium nickel cobalt aluminum-based complex oxide, and the lithium iron nickel manganese-based composite oxide.

Suitably, a lithium nickel manganese cobalt-based composite oxide represented by the following formula (I) can be used as the positive electrode active material.

LiₐNiₓMn_{y}Co_{z}O₂ (I)

Here, a satisfies 0.98≤a≤1.20. x, y, and z satisfy x+y+z=1. x preferably satisfies 0.20≤x≤0.60, and more preferably satisfies 0.34≤x≤0.60. y preferably satisfies 0<y≤0.50, and more preferably satisfies 0<y≤0.40. z preferably satisfies 0<z≤0.50, and more preferably satisfies 0<z≤0.40.

Examples of the lithium transition metal phosphate compound include lithium iron phosphate (LiFePO₄), lithium manganese phosphate (LiMnPO₄), and lithium iron manganese phosphate.

An average particle diameter (median diameter D50) of the positive electrode active material particles is not particularly limited, and is, for example, 0.05 μm or greater and 20 μm or smaller, preferably 0.5 μm or greater and 15 μm or smaller, and more preferably 3 μm or greater and 15 μm or smaller.

The average particle diameter (median diameter D50) of the positive electrode active material particles can be determined by, for example, a laser diffraction scattering method.

The positive electrode active material layer 54 contains hydrated alumina at least in a surface layer portion. The hydrated alumina has a hydroxyl group.

Examples of the hydrated alumina include aluminum oxyhydroxide (AlOOH), which is a crystalline alumina monohydrate; aluminum hydroxide (Al(OH)₃), which is a crystalline alumina trihydrate; and alumina gel which is an amorphous hydrated alumina. The crystalline hydrated alumina (that is, crystalline alumina monohydrate and crystalline alumina trihydrate) may be either α-type or β-type, and is preferably α-type. The hydrated alumina is preferably aluminum oxyhydroxide in that the effect of improving the low-temperature performance more increases.

An average particle diameter (median diameter D50) of the hydrated alumina is not particularly limited. When the average particle diameter of the hydrated alumina is too small, acid (particularly, HF) is likely to be generated in the non-aqueous electrolyte, which may cause deterioration of the positive electrode active material. Therefore, the average particle diameter of the hydrated alumina is preferably 0.5 μm or greater. On the other hand, when the average particle diameter of the hydrated alumina is too large, the effect of improving the ionic conductivity of a film to be formed tends to be small. Therefore, the average particle diameter of the hydrated alumina is preferably 3 μm or smaller. The average particle diameter (median diameter D50) of the hydrated alumina can be determined by, for example, a laser diffraction scattering method.

As described later, it is considered that the hydrated alumina has an effect of modifying a film formed on a surface of the positive electrode active material layer by lithium fluorosulfonate. The film formed by the lithium fluorosulfonate is often formed on the surface layer portion of the positive electrode active material layer 54. Therefore, in the present embodiment, the hydrated alumina is disposed at least on the surface layer portion.

The surface layer portion of the positive electrode active material layer 54 is a region including the surface of the positive electrode active material layer 54, for example, a region from the surface of the positive electrode active material layer 54 to a portion at 10% of the thickness of the positive electrode active material layer 54.

The region containing the hydrated alumina may be a region from the surface of the positive electrode active material layer 54 to a portion at 10% to 100% of the thickness of the positive electrode active material layer 54 (for example, from the surface of the positive electrode active material layer 54 to a portion at 20% to 70% of the thickness of the positive electrode active material layer 54). For example, the region may be a region from the surface of the positive electrode active material layer 54 to a portion at 50% of the thickness of the positive electrode active material layer 54, and a region from the surface of the positive electrode active material layer 54 to a portion at 20% of the thickness of the positive electrode active material layer 54. The entire positive electrode active material layer 54 may be a region containing the hydrated alumina.

When the hydrated alumina is disposed solely on the surface layer portion, first, a paste for forming a positive electrode active material layer, containing no hydrated alumina may be applied to the positive electrode current collector 52 and dried. Then, a paste for forming a positive electrode active material layer, containing hydrated alumina is applied thereon and dried.

A content of the hydrated alumina in the region of the positive electrode active material layer 54 where the hydrated alumina is contained is not particularly limited. When the content of the hydrated alumina in the region is too small, the effect of improving the low-temperature performance tends to decrease. Therefore, the content of the hydrated alumina in the region is preferably 1% by mass or more, and more preferably 5% by mass or more, with respect to the positive electrode active material. On the other hand, when the content of the hydrated alumina in the region is too large, a proportion of the positive electrode active material in the positive electrode active material layer tends to decrease, and a capacity tends to decrease. Therefore, the content of the hydrated alumina in the region is preferably 30% by mass or less, and more preferably 20% by mass or less, with respect to the positive electrode active material.

The positive electrode active material layer 54 may include a component in addition to the positive electrode active material and the hydrated alumina. Examples of the component include trilithium phosphate (Li₃PO₄), a conductive material, and a binder.

As the conductive material, for example, carbon black such as acetylene black (AB) and other carbon materials such as graphite can be suitably used. The content of the conductive material with respect to the positive electrode active material is preferably 1% by mass or more and 20% by mass or less, and more preferably 3% by mass or more and 15% by mass or less.

As the binder, for example, polyvinylidene fluoride (PVdF) can be used. The content of the binder with respect to the positive electrode active material is preferably 1% by mass or more and 20% by mass or less, and more preferably 3% by mass or more and 15% by mass or less.

The content of the trilithium phosphate with respect to the positive electrode active material is preferably 1% by mass or more and 10% by mass or less.

Examples of the negative electrode current collector 62 configuring the negative electrode sheet 60 include a copper foil. The negative electrode active material layer 64 contains a negative electrode active material. As the negative electrode active material, for example, a carbon material such as graphite, hard carbon, and soft carbon can be used. The graphite may be natural graphite or artificial graphite, and may be amorphous carbon-coated graphite in which graphite is coated with an amorphous carbon material.

The negative electrode active material layer 64 may include a component such as a binder and a thickener, in addition to the negative electrode active material. As the binder, for example, styrene-butadiene rubber (SBR) can be used. As the thickener, for example, carboxymethyl cellulose (CMC) can be used.

A content of the negative electrode active material in the negative electrode active material layer is preferably 90% by mass or more, and more preferably 95% by mass or more and 99% by mass or less. A content of the binder in the negative electrode active material layer is preferably 0.1% by mass or more and 8% by mass or less, and more preferably 0.5% by mass or more and 3% by mass or less. A content of the thickener in the negative electrode active material layer is preferably 0.3% by mass or more and 3% by mass or less, and more preferably 0.5% by mass or more and 2% by mass or less.

Examples of the separator 70 include a porous sheet (film) made of a resin such as polyethylene (PE), polypropylene (PP), polyester, cellulose, or polyamide. The porous sheet may have a single-layer structure or a layered structure of two or more layers (for example, a three-layer structure in which a PP layer is layered on both sides of a PE layer). A heat-resistant layer (HRL) may be provided on a surface of the separator 70.

The non-aqueous electrolyte 80 contains lithium fluorosulfonate. The lithium fluorosulfonate is a component involved in the formation of a film on a surface of the active material.

The non-aqueous electrolyte typically contains a non-aqueous solvent and a supporting electrolyte (supporting salt).

As the non-aqueous solvent, various kinds of organic solvents such as carbonates, ethers, esters, nitriles, sulfones, and lactones used for electrolytes of general lithium ion secondary batteries can be used without particular limitation. Specific examples of the non-aqueous solvent include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), and trifluorodimethyl carbonate (TFDMC). The non-aqueous solvents can be used alone or two or more kinds thereof can be used in an appropriate combination.

As the supporting salt, for example, a lithium salt such as LiPF₆, LiBF₄, and LiClO₄ (preferably LiPF₆) can be used. The concentration of the supporting salt is preferably 0.7 mol/L or higher and 1.3 mol/L or lower.

A content of the lithium fluorosulfonate in the non-aqueous electrolyte 80 is not particularly limited. When the content of the lithium fluorosulfonate is too small, the amount of film formation becomes too small. Therefore, the ionic conductivity of the positive electrode active material tends to decrease and the resistance tends to increase. Therefore, the content of the lithium fluorosulfonate in the non-aqueous electrolyte 80 is preferably 0.05% by mass or more. On the other hand, when the content of the lithium fluorosulfonate is too large, the amount of film formation (the amount of the formed film) becomes too large. Therefore, the electron conductivity of the positive electrode active material tends to decrease and the resistance tends to increase. Therefore, the content of the lithium fluorosulfonate in the non-aqueous electrolyte 80 is preferably 3.0% by mass or less.

It is preferable that the non-aqueous electrolyte 80 further contains lithium bis(oxalato)borate. In this case, the lithium bis(oxalato)borate promotes a decomposition reaction of the non-aqueous electrolyte 80, and a more uniform film can be obtained. The low-temperature performance of the lithium ion secondary battery 100 is further improved. A content of the lithium bis(oxalato)borate in the non-aqueous electrolyte 80 is preferably 0.1% by mass or more, in that an effect of uniformizing the film by the lithium bis(oxalato)borate is enhanced and the low-temperature performance of the lithium ion secondary battery 100 is further improved. On the other hand, when the content of lithium bis(oxalato)borate is too large, the decomposition reaction of the non-aqueous electrolyte 80 may occur too much, and the effect of uniformizing the film may be reduced. Therefore, the content of the lithium bis(oxalato)borate in the non-aqueous electrolyte 80 is preferably 4.0% by mass or less, and more preferably 1.0% by mass or less.

It is preferable that the non-aqueous electrolyte 80 further contains lithium difluorophosphate. In this case, the lithium difluorophosphate is decomposed and taken into the film, and can improve the ionic conductivity of the film (particularly, conductivity of ions (such as Li) serving as charge carriers). As a result, the low-temperature performance of the lithium ion secondary battery 100 can be further improved. A content of the lithium difluorophosphate in the non-aqueous electrolyte 80 is preferably 0.1% by mass or more, in that an effect of improving the ionic conductivity by the lithium difluorophosphate is enhanced and the low-temperature performance of the lithium ion secondary battery 100 is further improved. On the other hand, when the content of the lithium difluorophosphate is too large, the amount of film formation becomes too large, which may cause an increase in resistance. Therefore, the content of lithium difluorophosphate in the non-aqueous electrolyte 80 is preferably 4.0% by mass or less, and more preferably 1.0% by mass or less.

The non-aqueous electrolyte 80 preferably contains both the lithium bis(oxalato)borate and the lithium difluorophosphate. In this case, a synergistic effect is exerted, and the low-temperature performance is further improved.

The non-aqueous electrolyte 80 may further contain a component other than the components described above, for example, various additives such as: a gas generating agent such as biphenyl (BP) and cyclohexylbenzene (CHB); and a thickener, as long as the effects of the present disclosure are not significantly impaired.

As described above, in the lithium ion secondary battery 100 in which the lithium fluorosulfonate is added to the non-aqueous electrolyte 80, the low-temperature performance is enhanced by adding the hydrated alumina to at least the surface layer portion of the positive electrode active material layer. In particular, a discharge capacity when a large current flows at low temperature increases. The reason is considered as follows.

The lithium fluorosulfonate is decomposed in the positive electrode active material layer to form a film on the surface of the positive electrode active material. The film suppresses the decomposition of the non-aqueous electrolyte. However, on the other hand, the film has a low diffusivity of ions such as Li-ions, and thus acts as a resistor, adversely affecting low-temperature performance. The film is often formed on the surface layer portion of the positive electrode active material layer.

However, when the hydrated alumina is present at least in the surface layer portion of the positive electrode active material layer 54 as in the present embodiment, it is considered that the lithium fluorosulfonate and hydroxyl groups of the hydrated alumina react on the surface of the positive electrode active material so as to form a modified film. Specifically, it is considered that a film in which an inorganic compound in which Li—S—P—O—F is complexed and an organic compound are appropriately disposed is formed. It is considered that the film has high ion diffusivity, and thus improves the low-temperature performance.

The lithium ion secondary battery 100 configured as described above can be used for various applications. Suitable applications include a power supply for drive which is mounted on a vehicle such as electric vehicles (EV), hybrid vehicles (HV), and plug-in hybrid vehicles (PHV). The lithium ion secondary battery 100 can also be typically used in the form of a battery pack in which a plurality of batteries is connected in series and/or in parallel.

As an example, the rectangular lithium ion secondary battery 100 including the flat wound electrode body 20 is described. However, the non-aqueous electrolyte secondary battery disclosed herein can also be configured as a lithium ion secondary battery including a stacked electrode body. Also, the non-aqueous electrolyte secondary battery disclosed herein can also be configured as a cylindrical lithium ion secondary battery, a laminated lithium ion secondary battery, a coin type lithium ion secondary battery, or the like. In addition, the non-aqueous electrolyte secondary battery disclosed herein can be configured as a non-aqueous electrolyte secondary battery other than the lithium ion secondary battery.

Hereinafter, examples according to the present disclosure will be described, but it is not intended that the present disclosure is limited to those shown in the examples.

Production of Lithium Ion Secondary Battery for Evaluation

LiNi_{0.34}Co_{0.33}Mn_{0.33}O₂ (LNCM) having a layered rock salt structure as a positive electrode active material, an aluminum material (Al material) shown in Table 1, acetylene black (AB) as a conductive material, and polyvinylidene fluoride (PVdF) as a binder were mixed with N-methyl-2-pyrrolidone (NMP) at a mass ratio of LNCM:Al material:AB:PVdF=100:x:13:13 (x is a value shown in Table 1, and corresponds to a mass ratio (%) to the positive electrode active material), and a paste for forming a positive electrode active material layer was prepared.

The paste for forming a positive electrode active material layer was applied on an aluminum foil, dried, and then subjected to a press processing, whereby a positive electrode sheet was produced.

In addition, natural graphite (C) as a negative electrode active material, styrene butadiene rubber (SBR) as a binder, and carboxymethyl cellulose (CMC) as a thickener were mixed with ion-exchanged water at a mass ratio of C:SBR:CMC=98:1:1, and a paste for forming a negative electrode active material layer was prepared. The paste for forming a negative electrode active material layer was applied on a copper foil, dried, and then subjected to a press processing, whereby a negative electrode sheet was produced.

In addition, a porous polyolefin sheet was prepared as a separator sheet.

A mixed solvent containing ethylene carbonate (EC), ethyl methyl carbonate (EMC), and dimethyl carbonate (DMC) in a volume ratio of 1:1:1 was prepared, and LiPF₆ as a supporting salt was dissolved in the mixed solvent at a concentration of 1.0 mol/L. Further, a lithium non-aqueous electrolyte was prepared by adding lithium fluorosulfonate (LiFSO₃), lithium difluorophosphate (LiPO₂F₂), and lithium bis(oxalato)borate (LiBOB) so as to have the contents shown in Table 1.

An electrode body was produced using the positive electrode sheet, the negative electrode sheet, and the separator, and the electrode body was housed in a battery case together with the non-aqueous electrolyte. In this manner, a lithium ion secondary battery for evaluation of each of Examples and Comparative Examples was produced.

Evaluation of Low-Temperature Performance

For each lithium ion secondary battery for evaluation produced above, a discharge capacity obtained when a current of 20 A flowed in a low-temperature environment of −20° C. was determined. Next, for each lithium ion secondary battery for evaluation, a ratio of the discharge capacity when a predetermined reference value of the discharge capacity was set to 100 was calculated. Results are shown in Table 1.

TABLE 1

| | Positive electrode active | | | | | |
|---|---|---|---|---|---|---|
| | material layer | | | | | Discharge |
| | | Amount x of | | | | capacity |
| | | Al material | Electrolyte | | | at low |
| | Kind of Al | added | LiSO₃ | LiPO₂F₂ | LiBOB | temperature |
| | material | (% by mass) | (% by mass) | (% by mass) | (% by mass) | (relative value) |
| Example 1 | Aluminum | 1 | 0.05 | 0 | 0 | 111 |
| | oxyhydroxide | | | | | |
| Example 2 | Aluminum | 1 | 0.05 | 0.1 | 0.1 | 113 |
| | oxyhydroxide | | | | | |
| Example 3 | Aluminum | 1 | 3 | 0 | 0 | 100 |
| | oxyhydroxide | | | | | |
| Example 4 | Aluminum | 1 | 3 | 0.1 | 0.1 | 104 |
| | oxyhydroxide | | | | | |
| Example 5 | Aluminum | 30 | 0.05 | 0 | 0 | 112 |
| | oxyhydroxide | | | | | |
| Example 6 | Aluminum | 30 | 0.05 | 0.1 | 0.1 | 111 |
| | oxyhydroxide | | | | | |
| Example 7 | Aluminum | 30 | 3 | 0 | 0 | 128 |
| | oxyhydroxide | | | | | |
| Example 8 | Aluminum | 30 | 3 | 0.1 | 0.1 | 129 |
| | oxyhydroxide | | | | | |
| Example 9 | Aluminum | 1 | 1 | 0.1 | 0 | 101 |
| | oxyhydroxide | | | | | |
| Example 10 | Aluminum | 1 | 1 | 0 | 0.1 | 102 |
| | oxyhydroxide | | | | | |
| Example 11 | Aluminum | 10 | 2 | 0.1 | 0.1 | 130 |
| | oxyhydroxide | | | | | |
| Comparative | Aluminum | 1 | 0 | 0.1 | 0.1 | 89 |
| Example 1 | oxyhydroxide | | | | | |
| Comparative | Aluminum oxide | 1 | 0.05 | 0.1 | 0.1 | 75 |
| Example 2 | | | | | | |
| Comparative | — | 0 | 0.05 | 0 | 0 | 89 |
| Example 3 | | | | | | |
| Comparative | — | 0 | 3 | 0 | 0 | 88 |
| Example 4 | | | | | | |
| Comparative | — | 0 | 0.05 | 0.1 | 0.1 | 87 |
| Example 5 | | | | | | |

As shown in Table 1, in Examples 1 to 11 in which the lithium fluorosulfonate was added to the non-aqueous electrolyte and at least the surface layer portion of the positive electrode active material layer contained the hydrated alumina, it can be seen that the discharge capacity when a large current flowed at a low temperature was large.

On the other hand, in Comparative Example 1 in which the non-aqueous electrolyte did not contain the lithium fluorosulfonate, the discharge capacity was small. In Comparative Example 2 in which aluminum oxide having no hydroxyl group was used as the aluminum material, the discharge capacity was small. In Comparative Examples 3 to 5 in which the positive electrode active material layer did not contain an aluminum material, the discharge capacity was small.

Therefore, it can be seen that the non-aqueous electrolyte secondary battery disclosed herein has excellent low-temperature performance.

As above, although the specific examples of the present disclosure were described in detail, the specific examples are merely illustrations and do not limit claims. The technique described in the claims includes various modifications and changes of the specific examples illustrated above.

What is claimed is:

1. A non-aqueous electrolyte secondary battery comprising:
a positive electrode;
a negative electrode; and
a non-aqueous electrolyte, wherein:
the positive electrode includes a positive electrode current collector and a positive electrode active material layer provided on the positive electrode current collector;
the non-aqueous electrolyte contains lithium fluorosulfonate; and
the positive electrode active material layer contains a positive electrode active material, and the positive electrode active material layer contains hydrated alumina at least in a surface layer portion of the positive electrode active material layer.

2. The non-aqueous electrolyte secondary battery according to claim 1, wherein in a region of the positive electrode active material layer where the hydrated alumina is contained, a content of the hydrated alumina is 1% by mass or more and 30% by mass or less, with respect to the positive electrode active material contained in the region.

3. The non-aqueous electrolyte secondary battery according to claim 1, wherein the non-aqueous electrolyte further contains lithium bis(oxalato)borate.

4. The non-aqueous electrolyte secondary battery according to claim 1, wherein the non-aqueous electrolyte further contains lithium difluorophosphate.

5. The non-aqueous electrolyte secondary battery according to claim 1, wherein the hydrated alumina is aluminum oxyhydroxide.
